(19) United States
(12) Patent Application Publication
(10) Pub. No.: US 2020/0043325 A1
(43) Pub. Date: Feb. 6, 2020

(54) SYSTEMS AND METHODS FOR DETERMINING TRAFFIC CONDITIONS

(71) Applicant: BEIJING DIDI INFINITY TECHNOLOGY AND DEVELOPMENT CO., LTD., Beijing (CN)

(72) Inventors: Weili SUN, Beijing (CN); Xianghong LIU, Tianjin (CN); Bingbing LIU, Beijing (CN); Jianfeng YE, Beijing (CN)

(73) Assignee: BEIJING DIDI INFINITY TECHNOLOGY AND DEVELOPMENT CO., LTD., Beijing (CN)

(21) Appl. No.: 16/220,275

(22) Filed: Dec. 14, 2018

Related U.S. Application Data
(63) Continuation of application No. PCT/CN2018/098970, filed on Aug. 6, 2018.

(51) Int. Cl. G08G 1/01; G08G 1/052; G08G 1/065

(52) U.S. Cl. CPC G08G 1/0133; G08G 1/065; G08G 1/052

(57) ABSTRACT

The present disclosure relates to a system and method for determining a traffic condition. The systems may perform the methods to: obtain a length of a road segment, where an upstream intersection and a downstream intersection is linked by the road segment; determine a first queue length of a queue on the road segment at a first time point and a second queue length of the queue at a second time point; determine a duration of the second queue length, based on a cycle length of the first traffic light corresponding to the downstream intersection, a cycle length of the second traffic light corresponding to the upstream intersection, a free-flow speed corresponding to the road segment, a back-propagation wave speed corresponding to the road segment, and the first queue length; and determine whether the second queue length exceeds the length of the road segment.

### TECHNICAL FIELD

The present disclosure generally relates to systems and methods for determining road conditions, and in particular, systems and methods for determining traffic conditions.

### BACKGROUND

With more and more vehicles on the street in urban areas, traffic congestion becomes part of people's daily lives. In many forms of traffic congestion, traffic overflow is undoubtedly a more serious one. Traffic overflow is a certain flow direction of a certain section, caused by the influence of the factors such as road planning or traffic signal timing. In a traffic overflow, a queue of vehicles accumulates waiting for traffic within a certain period is greater than the length of the road section, and the queue extends to the upstream section. The spillover of the queue may lead to the gridlock at the intersection. Therefore, it is desirable to develop systems or methods for determining spillover on roads.

### SUMMARY

According to a first aspect of the present disclosure, a system is provided. The system may include at least one non-transitory storage medium including a set of instructions and one or more processors in communication with the at least one non-transitory storage medium. When executing the set of instructions, the one or more processors may be directed to perform one or more of the following operations. The one or more processors may obtain a length of a road segment, an upstream intersection and a downstream intersection being linked by the road segment. The one or more processors may obtain a cycle length of a first traffic light and a cycle length of a second traffic light, the first traffic light being located at the downstream intersection, the second traffic light being located at the upstream intersection. The one or more processors may determine a free-flow speed corresponding to the road segment and a back-propagation wave speed corresponding to the road segment. The one or more processors may determine a first queue length of a queue on the road segment at a first time point and a second queue length of the queue at a second time point. The one or more processors may determine a duration of the second queue length, based on the cycle length of the first traffic light, the cycle length of the second traffic light, the free-flow speed, the back-propagation wave speed, and the first queue length. The one or more processors may determine whether the second queue length exceeds the length of the road segment. The one or more processors may cause a display to display a visual representation of a traffic condition relating to the duration of the second queue length based on a result of the determination that second queue length exceeds the length of the road segment.

In some embodiments, a cycle length of a traffic light may include a green-light cycle length and a red-light cycle length. To determine the second queue length of the queue at a second time point, the one or more processors may determine a first growth parameter of the queue related to the green-light cycle length based on the free-flow speed and the back-propagation wave speed. The one or more processors may determine a second growth parameter of the queue related to the red-light cycle length based on the free-flow speed and the back-propagation wave speed. The one or more processors may determine the second queue length of the queue based on the first growth parameter and the second growth parameter.

In some embodiments, the duration of the second queue length may include a green-light spillover duration. To determine the second queue length of the queue at a second time point, the one or more processors may determine a reference queue length of the queue based on the cycle length of the first traffic light, the cycle length of the second traffic light, the free-flow speed, and the back-propagation wave speed. The one or more processors may determine a first length difference between the second queue length of the queue and the length of the road segment. The one or more processors may determine a second length difference between the second queue length of the queue and the reference queue length. The one or more processors may determine the green-light spillover duration based on a ratio of the first length difference and the second length difference. The one or more processors may display a visual representation of a second indicator related to the green-light spillover duration.

In some embodiments, the duration of the second queue length includes a red-light spillover duration. To determine the duration of the second queue length, the one or more processors may determine the red-light spillover duration based on a ratio of a difference between the reference queue length and the length of the road segment to a difference between the second queue length of the queue and the reference queue length. The one or more processors may display a third indicator related to the red-light spillover duration.

In some embodiments, to determine the duration of the second queue length, the one or more processors may determine a sum of the green-light spillover duration and the red-light spillover duration as the duration of the second queue length.

In some embodiments, the one or more processor may further determine whether the reference queue length exceeds the length of the road segment. The one or more processor may further determine the green-light spillover duration as the duration of the second queue length based on a result of the determination that the reference queue length exceeds the length of the road segment. The one or more processor may further cause a display to display a visual representation of a fourth indicator related to the green-light spillover duration.

In some embodiments, to determine the free-flow speed corresponding to the road segment, the one or more processors may obtain traffic data related to the road segment, the traffic data related to the road segment including a vehicle flow rate of the road segment and a vehicle density of the road segment corresponding to the vehicle flow rate. The one or more processors may determine a first vector corresponding to a first status of the road segment based on the traffic data related to the road segment. The first status may be that the vehicle flow rate of the road segment is positively correlated to the vehicle density of the road segment corresponding to the vehicle flow rate. The one or more processors may determine the free-flow speed based on the first vector.

In some embodiments, to determine the back-propagation wave speed corresponding to the road segment, the one or more processors may obtain traffic data related to the road segment. The traffic data related to the road segment may include a vehicle flow rate of the road segment and a vehicle density of the road segment corresponding to the vehicle flow rate. The one or more processors may determine a second vector corresponding to a second status of the road segment based on the traffic data related to the road segment. The second status may be that the vehicle flow rate of the road segment is negatively correlated to the vehicle density of the road segment corresponding to the vehicle flow rate. The one or more processors may determine the back-propagation wave speed based on the second vector.

According to yet another aspect of the present disclosure, a method is provided. The method may be implemented on a computing device for determining a traffic condition. The computing device may include a memory and one or more processors. The method may include one or more of the following operations. The one or more processors may obtain a length of a road segment, an upstream intersection and a downstream intersection being linked by the road segment. The one or more processors may obtain a cycle length of a first traffic light and a cycle length of a second traffic light, the first traffic light being located at the downstream intersection, the second traffic light being located at the upstream intersection. The one or more processors may determine a free-flow speed corresponding to the road segment and a back-propagation wave speed corresponding to the road segment. The one or more processors may determine a first queue length of a queue on the road segment at a first time point and a second queue length of the queue at a second time point. The one or more processors may determine a duration of the second queue length, based on the cycle length of the first traffic light, the cycle length of the second traffic light, the free-flow speed, the back-propagation wave speed, and the first queue length. The one or more processors may determine whether the second queue length exceeds the length of the road segment. The one or more processors may cause a display to display a visual representation of a traffic condition relating to the duration of the second queue length based on a result of the determination that second queue length exceeds the length of the road segment.

According to yet another aspect of the present disclosure, a non-transitory computer readable medium may embody a computer program product. The computer program product may comprise instructions may be executed by one or more processors. The one or more processors may obtain a length of a road segment, an upstream intersection and a downstream intersection being linked by the road segment. The one or more processors may obtain a cycle length of a first traffic light and a cycle length of a second traffic light, the first traffic light being located at the downstream intersection, the second traffic light being located at the upstream intersection. The one or more processors may determine a free-flow speed corresponding to the road segment and a back-propagation wave speed corresponding to the road segment. The one or more processors may determine a first queue length of a queue on the road segment at a first time point and a second queue length of the queue at a second time point. The one or more processors may determine a duration of the second queue length, based on the cycle length of the first traffic light, the cycle length of the second traffic light, the free-flow speed, the back-propagation wave speed, and the first queue length. The one or more processors may determine whether the second queue length exceeds the length of the road segment. The one or more processors may cause a display to display a visual representation of a traffic condition relating to the duration of the second queue length based on a result of the determination that second queue length exceeds the length of the road segment.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an exemplary system for determining traffic conditions according to some embodiments of the present disclosure;

FIG. 2 is a schematic diagram illustrating exemplary components of a computing device according to some embodiments of the present disclosure;

FIG. 3 is a schematic diagram illustrating hardware and/or software components of an exemplary mobile terminal according to some embodiments of the present disclosure;

FIG. 4 is a block diagram illustrating an exemplary processing engine according to some embodiments of the present disclosure;

FIG. 5A is a schematic diagram illustrating an exemplary one-way road network according to some embodiments of the present disclosure;

FIG. 5B illustrates a diagram illustrating exemplary relationships between the traffic flow rate of a road segment and the traffic density of the road segment

FIG. 6 is a time-space diagram that illustrates exemplary queue length trajectories on a road segment according to some embodiments of the present disclosure;

FIG. 7A is a schematic diagram illustrating exemplary queue length trajectories in spillover according to some embodiments of the present disclosure;

FIG. 7B is a schematic diagram illustrating an enlarged view of an exemplary queue length trajectories in spillover according to some embodiments of the present disclosure;

FIG. 8A is a schematic diagram illustrating exemplary queue length trajectories in spillover according to some embodiments of the present disclosure;

FIG. 8B is a schematic diagram illustrating an enlarged view of an exemplary queue length trajectories in spillover according to some embodiments of the present disclosure;

FIG. 9 is a flowchart illustrating an exemplary process for determining a traffic condition according to some embodiments of the present disclosure;

FIG. 10 is a flowchart illustrating an exemplary process for determining a queue length of a queue according to some embodiments of the present disclosure; and

FIG. 11 is a flowchart illustrating an exemplary process for determining a green-light spillover duration and/or a red-light spillover duration according to some embodiments of the present disclosure.

### DETAILED DESCRIPTION

In order to illustrate the technical solutions related to the embodiments of the present disclosure, brief introduction of the drawings referred to in the description of the embodiments is provided below.

Obviously, drawings described below are only some examples or embodiments of the present disclosure. Those having ordinary skills in the art, without further creative efforts, may apply the present disclosure to other similar scenarios according to these drawings. Unless stated otherwise or obvious from the context, the same reference numeral in the drawings refers to the same structure and operation.

As used in the disclosure and the appended claims, the singular forms “a,” “an,” and “the” include plural referents unless the content clearly dictates otherwise. It will be further understood that the terms “comprises,” “comprising,” “includes,” and/or “including” when used in the disclosure, specify the presence of stated steps and elements, but do not preclude the presence or addition of one or more other steps and elements.

Some modules of the system may be referred to in various ways according to some embodiments of the present disclosure. However, any number of different modules may be used and operated in a client terminal and/or a server. These modules are intended to be illustrative, not intended to limit the scope of the present disclosure. Different modules may be used in different aspects of the system and method.

According to some embodiments of the present disclosure, flowcharts are used to illustrate the operations performed by the system. It is to be expressly understood, the operations above or below may or may not be implemented in order. Conversely, the operations may be performed in inverted order, or simultaneously. Besides, one or more other operations may be added to the flowcharts, or one or more operations may be omitted from the flowchart.

Technical solutions of the embodiments of the present disclosure are described with reference to the drawings as described below. It is obvious that the described embodiments are not exhaustive and are not limiting. Other embodiments obtained, based on the embodiments set forth in the present disclosure, by those with ordinary skill in the art without any creative works are within the scope of the present disclosure.

In an aspect, the present disclosure is directed to systems and methods for traffic condition determination. The system may determine a discharge speed of a vehicle queue from the downstream intersection reaching the upstream. The system may further determine a whole intersection spillover time (IST) based on the discharge speed and traffic data of the road. The intersection spillover time may be used to determine and analyze the traffic condition of a road.

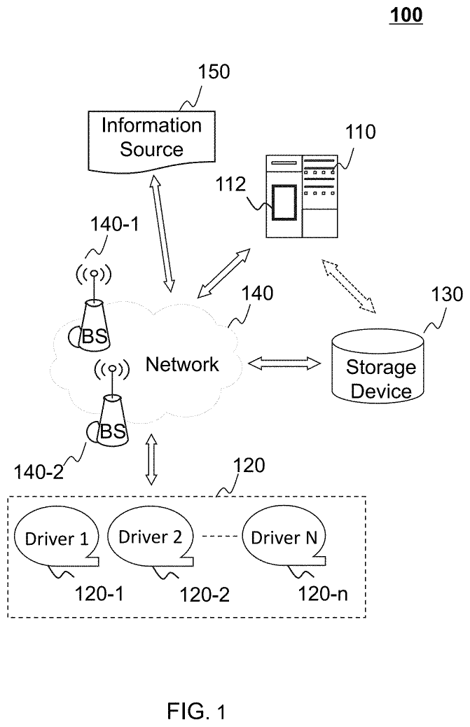

FIG. 1 is a schematic diagram illustrating an exemplary system for traffic condition determination according to some embodiments of the present disclosure. For example, the system 100 may be a platform for determining a light-cycle pattern to avoid or reduce vehicle spillover based on the track data of the vehicles obtained by the system 100. The system 100 may include a server 110, a driver terminal 120, a storage device 130, a network 140, and an information source 150. The server 110 may include a processing engine 112.

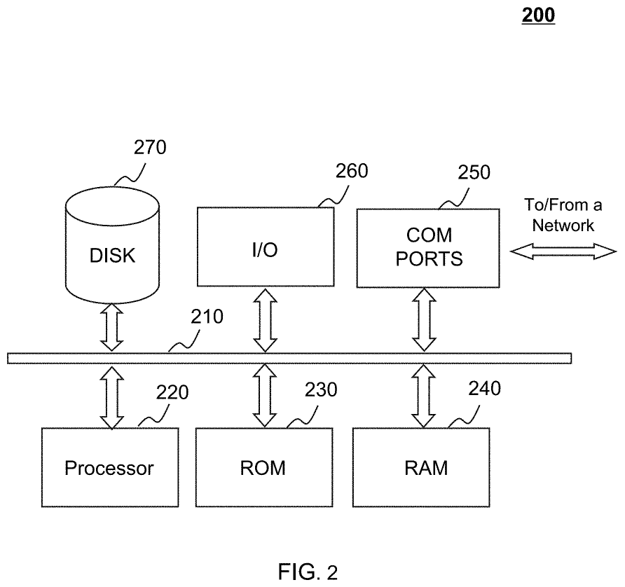

In some embodiments, the server 110 may perform a plurality of operations to determine the light-cycle patterns of traffic lights. The light-cycle pattern of a traffic light refers to a periodical rule of a plurality of repeated cycles of a traffic light being lit. A cycle of a traffic light may include a green-light duration and a red-light duration. The green-light duration may be a consistent value, and the red-light duration may be a consistent value. The server 110 may control the traffic lights according to the determined light-cycle patterns. In some embodiments, the server 110 may obtain the track data of a plurality of vehicles. The server 110 may determine the traffic condition based on the collected traffic data. In some embodiments, the server 110 may be a single server or a server group. The server group may be centralized, or distributed (e.g., the server 110 may be a distributed system). In some embodiments, the server 110 may be local or remote. For example, the server 110 may access information and/or data stored in the driver terminal 120, the information source 150, and/or the storage device 130 via the network 140. As another example, the server 110 may be directly connected to the driver terminal 120 and/or the storage device 130 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device having one or more components illustrated in FIG. 2 in the present disclosure.

In some embodiments, the server 110 may include a processing engine 112. The processing engine 112 may determine a light-cycle pattern for determining traffic conditions. In some embodiments, the processing engine 112 may include one or more processing engines (e.g., single-core processing engine(s) or multi-core processor(s)). Merely by way of example, the processing engine 112 may include a central processing unit (CPU), an application-specific integrated circuit (ASIC), an application-specific instruction-set processor (ASIP), a graphics processing unit (GPU), a physics processing unit (PPU), a digital signal processor (DSP), a field programmable gate array (FPGA), a programmable logic device (PLD), a controller, a microcontroller unit, a reduced instruction-set computer (RISC), a microprocessor, or the like, or any combination thereof.

In some embodiments, the driver terminal 120 may transmit positioning information associated with a vehicle to the server 110. For example, the driver terminal 120 may be a smartphone equipped with a global positioning system (GPS) chipset capable of determining the position of the smartphone. The driver terminal 120 may determine its positions over time and transmit the position data (also referred as the track data) to the server 110. The server 110 may treat the position data as the track data of a vehicle associated with the user of the driver terminal 120 since the positions of the driver terminal 120 may be the same (or almost the same) as the positions of the vehicle. As another example, the driver terminal 120 may be a computing device installed in a vehicle and equipped with a GPS chipset. The driver terminal 120 may determine its positions over time and transmit the position data to the server 110. The server 110 may further obtain track data corresponding to the positioning information. For example, the track data may include a plurality of positions of the driver terminal 120 and/or the vehicles.

In some embodiments, the driver terminal 120 may include a mobile device, a tablet computer, a laptop computer, and a built-in device in a motor vehicle, or the like, or any combination thereof. In some embodiments, the mobile device may include a smart home device, a wearable device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a smart bracelet, a smart footgear, a smart glass, a smart helmet, a smartwatch, a smart clothing, a smart backpack, a smart accessory, or the like, or any combination thereof. In some embodiments, the smart mobile device may include a smartphone, a personal digital assistant (PDA), a gaming device, a navigation device, or the like, or any combination thereof. In some embodiments, the built-in device in the motor vehicle may include an onboard computer, an onboard television, etc. In some embodiments, the driver terminal 120 may include a device with positioning technology for locating the position of the vehicle (e.g., a device equipped with a GPS chipset).

The storage device 130 may store data and/or instructions. In some embodiments, the storage device 130 may store data obtained/acquired from the driver terminal 120. In some embodiments, the storage device 130 may store data and/or instructions that the server 110 may execute or use to perform exemplary methods described in the present disclosure. In some embodiments, the storage device 130 may include a mass storage, removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include random-access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (PEROM), an electrically erasable programmable ROM (EEPROM), a compact disk ROM (CD-ROM), and a digital versatile disk ROM, etc. In some embodiments, the storage device 130 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage device 130 may be connected to the network 140 to communicate with one or more components in the system 100 (e.g., the server 110, the driver terminal 120). One or more components in the system 100 may access the data or instructions stored in the storage device 130 via the network 140. In some embodiments, the storage device 130 may be directly connected to or communicate with one or more components in the system 100 (e.g., the server 110, the driver terminal 120). In some embodiments, the storage device 130 may be part of the server 110.

The network 140 may facilitate exchange of information and/or data. In some embodiments, one or more components in the system 100 (e.g., the server 110, the driver terminal 120, the storage device 130) may send and/or receive information and/or data to/from another component (s) in the system 100 via the network 140. For example, the server 110 may obtain/acquire the trajectory data of the vehicles from a terminal via the network 140. In some embodiments, the network 140 may be any type of wired or wireless network, or combination thereof. Merely by way of example, the network 140 may include a cable network, a wireline network, an optical fiber network, a tele communications network, an intranet, an Internet, a local area network (LAN), a wide area network (WAN), a wireless local area network (WLAN), a metropolitan area network (MAN), a wide area network (WAN), a public telephone switched network (PSTN), a Bluetooth™ network, a ZigBee™ network, a near field communication (NFC) network, a global system for mobile communications (GSM) network, a code-division multiple access (CDMA) network, a time-division multiple access (TDMA) network, a general packet radio service (GPRS) network, an enhanced data rate for GSM evolution (EDGE) network, a wideband code division multiple access (WCDMA) network, a high speed downlink packet access (HSDPA) network, a long term evolution (LTE) network, a user datagram protocol (UDP) network, a transmission control protocol/Internet protocol (TCP/IP) network, a short message service (SMS) network, a wireless application protocol (WAP) network, a ultra wide band (UWB) network, an infrared ray, or the like, or any combination thereof. In some embodiments, the system 100 may include one or more network access points. For example, the system 100 may include wired or wireless network access points such as base stations and/or wireless access points 140-1, 140-2, . . . , through which one or more components of the system 100 may be connected to the network 140 to exchange data and/or information.

The information source 150 may be a source configured to provide other information for the system 100. The information source 150 may provide the system 100 with service information, such as weather conditions, traffic information, information of laws and regulations, news events, or the like. In some embodiments, the information source 150 may include an official traffic database, which provides historical and/or current traffic data (e.g., a congestion period, traffic light pattern). The server 110 may obtain the cycle length of a traffic light from the information source 150. The cycle length of a traffic light refers to a periodical duration of the traffic light including a green light duration, a red light duration, and/or a yellow light duration. In the present disclosure, the red-light duration and the green-light duration are discussed while the yellow-light duration is not discussed, but a person having ordinary skill in the art would understand how to include the yellow-light duration in view of the present disclosure without undue experimentation. In some embodiments, the yellow-light duration may be considered to be included in the green-light duration or the red light duration. The information source 150 may be implemented in a single central server, multiple servers connected via a communication link, or multiple personal devices. When the information source 150 is implemented in multiple personal devices, the personal devices can generate content (e.g., as referred to as the “user-generated content”), for example, by uploading text, voice, image, and video to a cloud server. An information source may be generated by the multiple personal devices and the cloud server.

FIG. 2 is a schematic diagram illustrating exemplary components of a computing device according to some embodiments of the present disclosure. The server 110, the driver terminal 120, and/or the storage device 130 may be implemented on the computing device 200 according to some embodiments of the present disclosure. The particular system may use a functional block diagram to explain the hardware platform containing one or more user interfaces. The computer may be a computer with general or specific functions. Both types of the computers may be configured to implement any particular system according to some embodiments of the present disclosure. Computing device 200 may be configured to implement any components that perform one or more functions disclosed in the present disclosure. For example, the computing device 200 may implement any component of the system 100 as described herein. In FIGS. 1 and 2, only one such computer device is shown purely for convenience purposes. One of ordinary skill in the art would understand at the time of filing of this application that the computer functions relating to the service as described herein may be implemented in a distributed fashion on a number of similar platforms, to distribute the processing load.

The computing device 200, for example, may include COM ports 250 connected to and from a network connected thereto to facilitate data communications. The computing device 200 may also include a processor (e.g., the processor 220), in the form of one or more processors (e.g., logic circuits), for executing program instructions. For example, the processor 220 may include interface circuits and processing circuits therein. The interface circuits may be configured to receive electronic signals from a bus 210, wherein the electronic signals encode structured data and/or instructions for the processing circuits to process. The processing circuits may conduct logic calculations, and then determine a conclusion, a result, and/or an instruction encoded as electronic signals. Then the interface circuits may send out the electronic signals from the processing circuits via the bus 210.

The exemplary computing device may include the internal communication bus 210, program storage and data storage of different forms including, for example, a disk 270, and a read-only memory (ROM) 230, or a random access memory (RAM) 240, for various data files to be processed and/or transmitted by the computing device. The exemplary computing device may also include program instructions stored in the ROM 230, RAM 240, and/or another type of non-transitory storage medium to be executed by the processor 220. The methods and/or processes of the present disclosure may be implemented as the program instructions. The computing device 200 also includes an I/O component 260, supporting input/output between the computer and other components. The computing device 200 may also receive programming and data via network communications.

Merely for illustration, only one CPU and/or processor is illustrated in FIG. 2. Multiple CPUs and/or processors are also contemplated; thus operations and/or method steps performed by one CPU and/or processor as described in the present disclosure may also be jointly or separately performed by the multiple CPUs and/or processors. For example, if in the present disclosure the CPU and/or processor of the computing device 200 executes both step A and step B, it should be understood that step A and step B may also be performed by two different CPUs and/or processors jointly or separately in the computing device 200 (e.g., the first processor executes step A and the second processor executes step B, or the first and second processors jointly execute steps A and B).

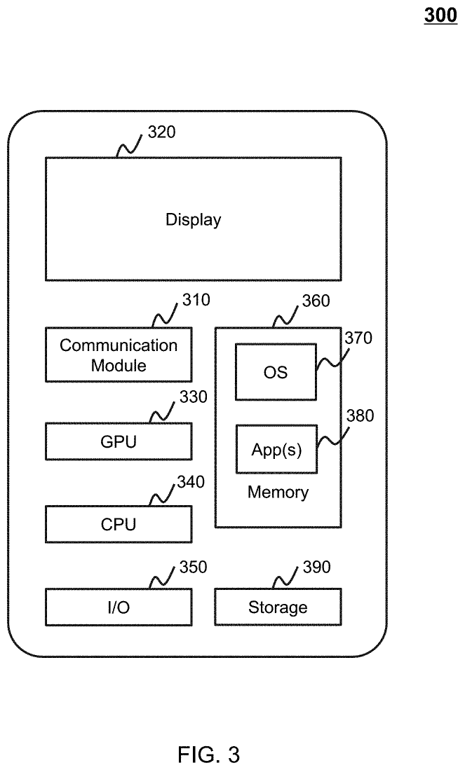

FIG. 3 is a block diagram illustrating exemplary hardware and/or software components of an exemplary mobile device according to some embodiments of the present disclosure. The driver terminal 120 may be implemented on the mobile device 300 according to some embodiments of the present disclosure. As illustrated in FIG. 3, the mobile device 300 may include a communication module 310, a display 320, a graphics processing unit (GPU) 330, a central processing unit (CPU) 340, an I/O 350, a memory 360, and a storage 390. The CPU 340 may include interface circuits and processing circuits similar to the processor 220. In some embodiments, any other suitable component, including but not limited to a system bus or a controller (not shown), may also be included in the mobile device 300. In some embodiments, a mobile operating system 370 (e.g., iOS™, Android™ Windows Phone™) and one or more applications 380 may be loaded into the memory 360 from the storage 390 in order to be executed by the CPU 340. The applications 380 may include a browser or any other suitable mobile apps for transmitting the trajectory data to the server 110. User interaction with the information stream may be achieved via the I/O devices 350 and provided to the processing engine 112 and/or other components of the system 100 via the network 140.

In order to implement various modules, units and their functions described above, a computer hardware platform may be used as hardware platforms of one or more elements (e.g., a component of the server 110 described in FIG. 1). Since these hardware elements, operating systems, and program languages are common, it may be assumed that persons skilled in the art may be familiar with these techniques and they may be able to provide information required in the traffic lights controlling according to the techniques described in the present disclosure. A computer with user interface may be used as a personal computer (PC), or other types of workstations or terminal devices. After being properly programmed, a computer with user interface may be used as a server. It may be considered that those skilled in the art may also be familiar with such structures, programs, or general operations of this type of computer device. Thus, extra explanations are not described for the figures.

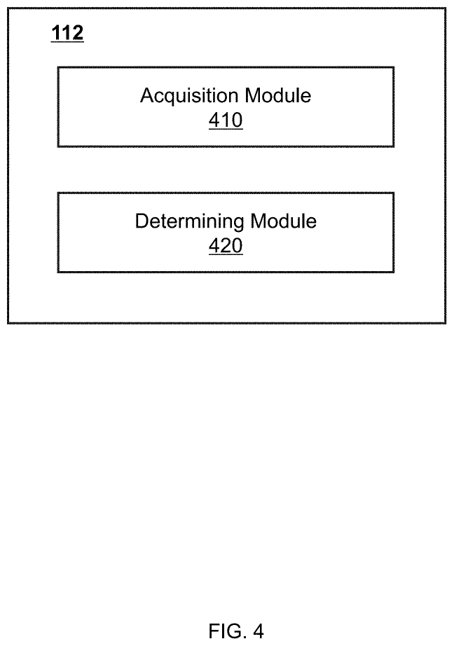

FIG. 4 is a block diagram illustrating an exemplary processing engine 112 according to some embodiments of the present disclosure. The processing engine 112 may include an acquisition module 410, and a determining module 420.

The acquisition module 410 may obtain a length of a road segment. An upstream intersection and a downstream intersection may be linked by the road segment. The length of the road segment may include a length of the upstream intersection.

The acquisition module 410 may obtain a cycle length of a first traffic light and a cycle length of a second traffic light. The first traffic light may be located at the downstream intersection. The second traffic light may be located at the upstream intersection. The cycle length of the traffic light may include a green-light cycle length and a red-light cycle length. For example, the cycle length may include a red light of 50 seconds and a green light time of 50 seconds.

The acquisition module 410 may obtain traffic data related to the road segment. The traffic data may include a vehicle flow rate of the road segment and a vehicle density of the road segment corresponding to the vehicle flow rate. In some embodiments, the acquisition module 410 may obtain historical data associated with a plurality of vehicles. The historical data may include GPS information associated with the plurality of vehicles and time information associated with the plurality of vehicles. The determining module 420 may determine a free-flow speed corresponding to the road segment and a back-propagation wave speed corresponding to the road segment.

The determining module 420 may determine a free-flow speed corresponding to the road segment and a back-propagation wave speed corresponding to the road segment.

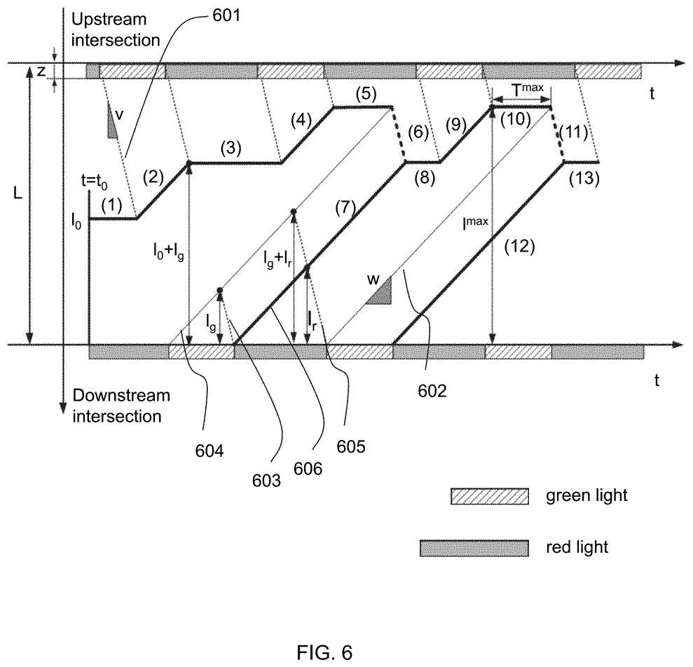

The determining module 420 may determine a first queue length of a queue on the road segment at a first time point and a second queue length of the queue at a second time point. The first queue length may be the same as the initial queue length l₀ which is described in FIG. 6. The second queue length of the queue may be the same as the maximum queue length l^{max} as illustrated in FIG. 6.

The determining module 420 may determine a duration of the second queue length, based on the cycle length of the first traffic light, the cycle length of the second traffic light, the free-flow speed, the back-propagation wave speed, and the first queue length. Specifically, the determining module 420 may determine a first growth parameter of a queue related to a green-light cycle length based on a free-flow speed and a back-propagation wave speed. The first growth parameter may be the same as the parameter l_{g} which is described in FIG. 6. The determining module 420 may determine a second growth parameter of the queue related to the red-light cycle length based on the free-flow speed and the back-propagation wave speed. The second growth parameter may be the same as the parameter lᵣ which is described in FIG. 6. The determining module 420 may determine the second queue length of the queue based on the first growth parameter and the second growth parameter. The determining module 420 may determine the duration of the second queue length, based on the cycle length of the first traffic light, the cycle length of the second traffic light, the free-flow speed, the back-propagation wave speed, and the first queue length.

The determining module 420 may determine whether the second queue length exceeds the length of the road segment.

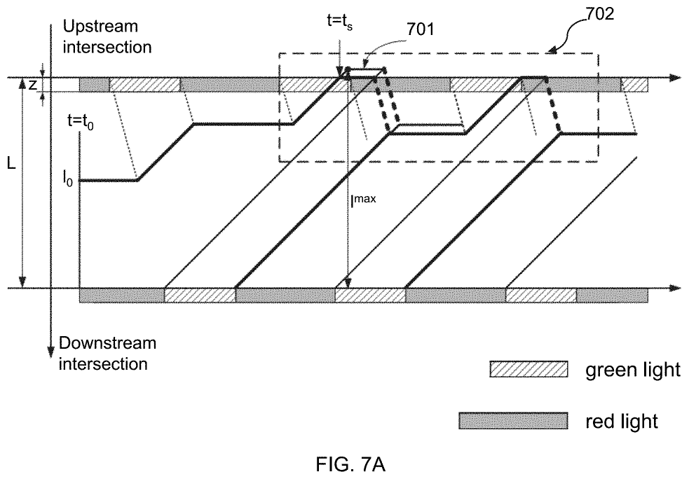

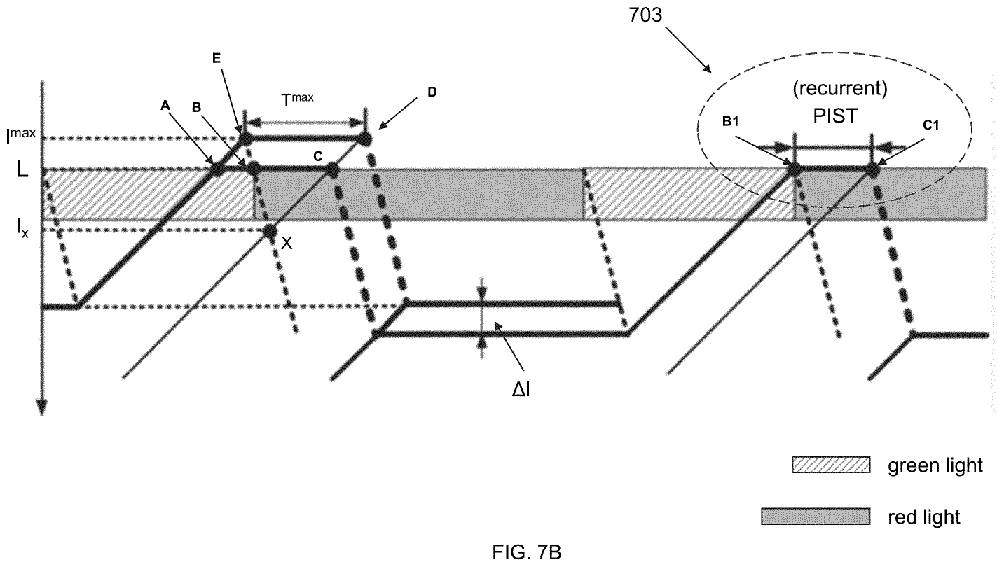

The determining module 420 may determine a reference queue length of a queue based on a cycle length of a first traffic light, a cycle length of a second traffic light, a free-flow speed, and a back-propagation wave speed. The reference queue length may be the same as the parameter lₓ which is described in FIGS. 7A and 7B.

The determining module 420 may determine whether the reference queue length is larger than the length of the road segment. If the determining module 420 determine that the reference queue length is not larger than the length of the road segment, the determining module 420 may determine a first length difference between the second queue length of the queue and the length of the road segment. The determining module 420 may determine a second length difference between the second queue length of the queue and the reference queue length. The determining module 420 may determine the green-light spillover duration based on a ratio of the first length difference and the second length difference. The determining module 420 may determine a red-light spillover duration based on a ratio of a difference between the reference queue length and the length of the road segment to a difference between the second queue length of the queue and the reference queue length.

If the determining module 420 determines that the reference queue length is larger than the length of the road segment, the determining module 420 may determine a green-light spillover duration.

It should be noted that the descriptions above in relation to the processing engine 112 are provided for the purposes of illustration, and not intended to limit the scope of the present disclosure. For persons having ordinary skills in the art, various variations and modifications may be conducted under the guidance of the present disclosure. However, those variations and modifications do not depart the scope of the present disclosure. For example, the processing engine 112 may further include a storage module (not shown in FIG. 4). The storage module may be configured to store data generated during any process performed by any component of in the processing engine 112. As another example, each of components of the processing engine 112 may associate with a storage module. Additionally or alternatively, the components of the processing engine 112 may share a common storage module. Similar modifications should fall within the scope of the present disclosure.

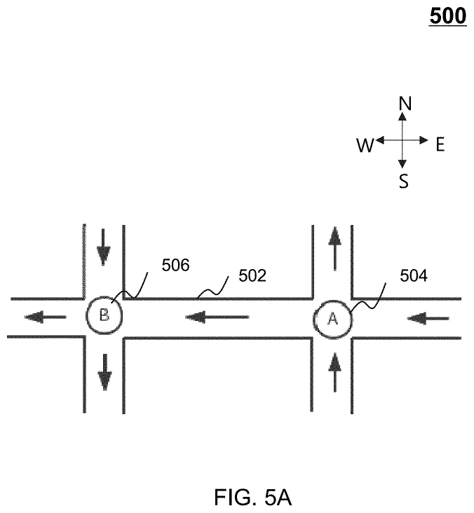

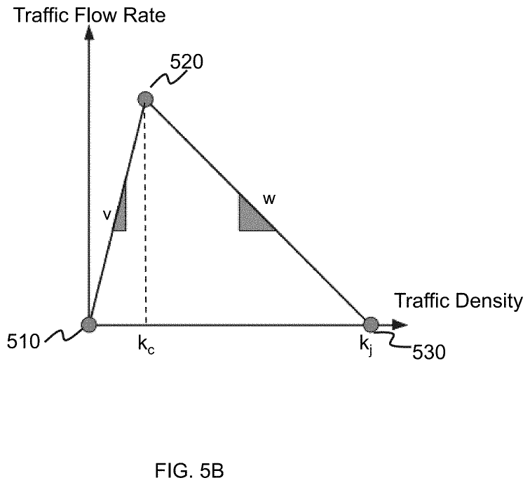

FIG. 5A is a schematic diagram illustrating an exemplary one-way road network according to some embodiments of the present disclosure. FIG. 5A is a simplified one-way road network including an upstream intersection 504 (i.e., the intersection A) and a downstream intersection 506 (i.e., the intersection B) connected by a road segment 502. In some embodiments, the turning movements of vehicles in the one-way road network 500 may be forbidden. In some embodiments, when the traffic condition is gridlock at a period on the road segment 502, a plurality of vehicles in the queue may be stopped to wait on the road segment 502 to pass the downstream intersection 506. If the queue cannot be fully discharged within a cycle of a traffic light at the downstream intersection 506, a residual queue may be formed and even spill to the upstream intersection 504, which may cause the gridlock of the upstream intersection 504. On the other hand, a gridlock may begin with queue spillover on one road segment (or link) and then spread to the adjacent road segment (or link). If the queue spillover is reduced or controlled, the gridlock may be prevented. More descriptions about the queue spillover may be found elsewhere in the present disclosure (e.g., FIGS. 6, 7A-7B, and 8A-8B, and the descriptions thereof).

It should be noted that the above description is merely provided for the purposes of illustration, and not intended to limit the scope of the present disclosure. For persons having ordinary skills in the art, multiple variations and modifications may be made under the teachings of the present disclosure. For example, the one-way road network 500 may include but not limited that two intersections, such as three intersections.

FIG. 5B illustrates a diagram illustrating exemplary relationships between a traffic flow rate of a road segment and a traffic density of the road segment. The term “traffic flow rate” (or “vehicle flow rate”) of a road segment used in the present disclosure refers to a rate at which vehicles pass a fixed point of the road segment. The term “traffic density” (or “vehicle density”) of the road segment used in the present disclosure refers to a count of vehicles over a stretch of the road segment. Both the traffic flow rate and traffic density of the road segment may be determined based on traffic data of the road segment collected. For instance, traffic flow rate and traffic density of the road segment may be determined based on a moving observer technique. The traffic data may include a count of vehicles passing the fixed point of the road segment or the velocity of a vehicle passing the fixed point of the road segment. The traffic data may be collected based on a manual counting technique, which may include assigning a person to record traffic as it passes. Alternatively or additionally, traffic data may be collected based on an automatic counting technique, which may include installing a detector on the fixed point of the road segment to record traffic as it passes. Exemplary detector for traffic data collection may include but not limited to pneumatic tubes, inductive loops, weigh-in-motion sensors, radar detectors, video cameras, or the like, or any combination thereof.

As shown in FIG. 5B, several statuses of a road segment may arise, including but not limited to, free-flowing status, saturated status, and capacity status. In the free-flowing status, represented by a first vector from 510 pointing to 520 as shown in FIG. 5B, the traffic density is low enough (inferior to the critical density k_{c} as shown in FIG. 5B) that vehicles are not impeded by each other and travel at a free-flow speed v, represented by a slope of the first vector as shown in FIG. 5B. In some embodiments, the free-flow speed v may be related to a speed limit of the road segment regulated by the law. In the saturated status, the traffic density is at the maximum and set at jam density kⱼ, as shown in FIG. 5. Vehicles may no longer travel and wait in a queue. In the capacity status, represented by a second vector from 520 pointing to 530 as shown in FIG. 5B, the traffic density is between k_{c} and kⱼ. As a result, vehicles may impede each other and reduce their speed accordingly. A slope of the second vector may be related to a back-propagation wave speed w. The back-propagation wave speed w may be determined based on Equation (1) as follows:

$$w = \frac{{q}_{c} - {q}_{j}}{{ρ}_{c} - {ρ}_{j}} , \qquad ( 1 )$$

where q_{c} and ρ_{c} denote a traffic flow rate and a traffic density for the capacity status, respectively; and qⱼ and ρⱼ denote a traffic flow rate and a traffic density for the saturated status, respectively.

FIG. 6 is a schematic diagram illustrating exemplary queue length trajectories on a road segment according to some embodiments of the present disclosure. FIG. 6 shows an example how a queue length trajectory (i.e., the position of the last queued vehicle in a road segment) moves in a time-space diagram. In some embodiments, the queue length trajectory refers to a path of the last queued vehicle in a road segment. The horizontal axis of the time-space diagram may represent time, and the vertical axis of the time-space diagram may represent a position of the last queued vehicle at a time point. A traffic light may be at a downstream intersection (which is also referred herein as the first traffic light), and a traffic light may be at an upstream intersection (which is also referred herein as the second traffic light). The downstream intersection (e.g., the downstream intersection 506 shown in FIG. 5A) and the upstream intersection (e.g., the upstream intersection 504 shown in FIG. 5A) may be connected by the road segment (e.g., the road segment 502 shown in FIG. 5A). L denotes the length of the road segment, which is the distance from the upstream intersection to downstream intersection. z denotes the length of the upstream intersection. Two groups of parallel auxiliary lines, for example, the auxiliary lines 601, 603, 605 and the auxiliary lines 602, 604, 606 may be depicted to help the determination of the queue length. One group including the auxiliary lines 601, 603, and 605 may start from a phase switch time of an upstream traffic signal and move toward the bottom right at a free-flow speed v. The other group including the auxiliary lines 602, 604, and 606 may start from a phase switch time of a downstream signal and move towards top right at a back-propagate speed w. The queue length trajectory may be shown by a plurality of bold black lines that consist of many stages such as Stage (1), Stage (2), . . . , and so on.

The queue length trajectory may increase if vehicles from the upstream join the queue (e.g., Stage (4) as shown in FIG. 6), and the queue length trajectory may remain unchanged if no vehicle comes from the upstream (e.g., Stage (5) as shown in FIG. 6). The decreasing lines (e.g., the dashed lines shown in Stage (6) in FIG. 6) may represent the positions of the last vehicle of the queue during discharging. In some embodiments, the initial condition at time t=t₀ may be assumed as that a queue with no vehicles (i.e., the number of the vehicles equal to n₀) accumulates on the road. The initial queue length l₀ may be given by l₀=n₀×ρⱼw. Due to a relatively large initial value of l₀, the initial queue may be not able to be dissolved in a first cycle but may be dissolved in a second cycle. In this case, l₀ may satisfy the following inequality (2):

lᵣ+l_{g}<l₀+l_{g}≤2(lᵣ+l_{g}) (2),

where l_{g} denotes a first growth parameter of the queue related to a green-light duration, and lᵣ denotes a second growth parameter of the queue related to a red-light duration. The first growth parameter may correspond to the growth of the queue length in one green light period, and the second growth parameter may correspond to the growth of the queue length in one red light period. As illustrated in FIG. 6, the first growth parameter may be determined based on a triangle formed by auxiliary lines 603, 604 and the horizontal axis including a green-light cycle length. The second growth parameter may be determined based on a triangle formed by auxiliary lines 605, 606 and the horizontal axis including a red-light cycle length. The slope of the auxiliary line 603 or 605 may be the free-flow speed v, and the slope of the auxiliary line 604 or 606 may be the back-propagation wave speed w. In some embodiments, l_{g} may be given by Equation (3) as follows:

$${l}_{g} = {g}_{0} \frac{wv}{w + v} , \qquad ( 3 )$$

where g₀ denotes a green-light duration, and lᵣ may be given by Equation (4) as follows:

$${l}_{r} = {r}_{0} \frac{wv}{w + v} = ( c - {g}_{0} ) \frac{wv}{w + v} , \qquad ( 4 )$$

where c denotes a cycle of a traffic light including a green-light duration and a red-light duration.

The queue length trajectory may finally converge to a cyclic recurrent pattern shown by a combination of stages (7) to (10) in FIG. 6. A maximum queue length l^{max} for this case may be given by Equation (5) as follows:

l^{max}=l₀+2l_{g} (5).

In this case, T^{max} denotes the duration that the maximum queue length l^{max} lasts. Equation (6) may be determined based on the similarity of triangles, as follows:

$$\frac{{T}^{max}}{c + {g}_{0}} = \frac{{l}^{max} - 2 {l}_{g} - {l}_{r}}{2 {l}_{g} + {l}_{r}} = \frac{{l}_{0} - {l}_{r}}{2 {l}_{g} + {l}_{r}} . \qquad ( 6 )$$

Then, the value of T^{max} may be determined by Equation (7) as follows:

$${T}^{max} = ( {l}_{0} - {l}_{r} ) \frac{c + {g}_{0}}{2 {l}_{g} + {l}_{r}} = ( {l}_{0} - {l}_{r} ) \frac{wv}{w + v} . \qquad ( 7 )$$

In some embodiments, given different initial values of l₀, the processing engine 112 may determine a general expression of l^{max} and T^{max} as follows:

$$\begin{matrix}{l}^{max} = {l}_{0} + {l}_{g} \cdot ceil ( \frac{{l}_{0}}{{l}_{r}} ) , & ( 8 ) \\ {T}^{max} = ( {l}_{0} - {l}_{r} \cdot floor ( \frac{{l}_{0}}{{l}_{r}} ) ) \cdot \frac{wv}{w + v} = mod ( {l}_{0} , {l}_{r} ) \cdot \frac{wv}{w + v} , & ( 9 )\end{matrix}$$

where function ceil(x) rounds x to the nearest integer towards infinity, function floor(x) rounds x to a nearest integer towards minus infinity, and function mod(x,y) refers to a reminder after dividing x by y.

FIG. 7A is a schematic diagram illustrating exemplary queue length trajectories in spillover on one road segment according to some embodiments of the present disclosure. FIG. 7A is a time-space diagram. As shown in FIG. 7A, L denotes the length of the road segment, which is the distance from the upstream intersection to downstream intersection. z denotes the length of the upstream intersection. The first traffic light is at the downstream intersection. The second traffic light is at the upstream intersection.

An actual queue length trajectory on the road segment is bold black lines that consist of many stages in FIG. 7A, while a reference trajectory 701 (i.e., an initial trajectory shown in FIG. 7A) in the first case is also depicted for comparison. At time t=tₛ, the queue length trajectory reaches the stop-line of the upstream intersection and the queue spills to the upstream and fully blocks the upstream intersection. The actual maximum queue length (i.e., lₘₐₓ) that is equal to the length of the road segment (i.e., L) is held until the back-propagation wave from the downstream intersection reaches the upstream intersection when a traffic light has already turned to red. The queue length trajectory may be shown by a plurality of bold black lines that consist of many stages in FIG. 7A. An initial trajectory may be represented by 701. A partial time-space diagram that includes a spillover may be represented by 702. An enlarge time-space diagram about the partial time-space diagram 702 may be shown in FIG. 7B.

A whole intersection spillover time (IST) refers to a duration that the queue length trajectory blocks the upstream intersection. In some embodiments, the whole intersection spillover time (IST) may be divided into two distinct parts, namely, a backward intersection spillover time (BIST) and a perpendicular intersection spillover time (PIST). The BIST may also be referred to as a green-light spillover duration in the present disclosure. The PIST may also be referred to as a red-light spillover duration in the present disclosure. It should be understood that once spillover takes place on the road segment, on one hand, the spillover may spread backward along the road segment, which means vehicles from the upstream cannot enter the road near the end of the green light duration. Thus, a backward intersection spillover time (BIST) that the queue length trajectory impedes upstream traffic entering the link may arise in this situation. On the other hand, the spillover may spread perpendicular to the road, which means vehicles from the cross street cannot pass the intersection at the beginning of their green-light duration (which is red-light duration for the described road). Thus a perpendicular intersection spillover time (PIST) that the queue length trajectory blocks traffic from the cross street may arise in this situation. The spillover part of the time-space diagram may be denoted by a dashed box 702. In some embodiments, the whole intersection spillover time may be described as:

IST=BIST+PIST (10).

FIG. 7B shows an enlarged view of the box 702 (i.e., spillover portion) in FIG. 7A. As shown in FIG. 7B, the box ACDE may be a parallelogram. Consequently, the IST (indicated by a length of AC in FIG. 7B) may equal to the T^{max} (indicated by the length of DE in FIG. 7B as calculated in Equation (11), i.e.,

$$I S T = {T}^{max} == mod ( {l}_{0} , {l}_{r} ) \cdot \frac{wv}{w + v} . \qquad ( 11 )$$

In this case, the length of AB indicates BIST, and the length of BC indicates PIST. According to the similarity of triangles EAB, XCB and XDE, BIST and PIST may be determined according to Equation (12) and Equation (13), respectively, as follows:

$$\begin{matrix}B I S T = \frac{AB}{DE} \cdot I S T = \frac{{l}^{max} - L}{{l}^{max} - {l}_{X}} {T}^{max} , & ( 12 ) \\ P I S T = \frac{BC}{DE} \cdot I S T = \frac{L - {l}_{x}}{{l}^{max} - {l}_{X}} {T}^{max} , & ( 13 )\end{matrix}$$

where X is the nearest crossover point to the upstream intersection that is on both the upstream red wave and downstream green wave simultaneously. A value of l^{max} and a vale of T^{max} are given in Equations (8) and (9), and the position of X may be determined according to Equation (14) as follows:

$${l}_{X} = {l}_{g} + ( {l}_{g} + {l}_{r} ) \cdot floor ( \frac{{l}_{0}}{{l}_{r}} ) , \qquad ( 14 )$$

In some embodiments, the BIST may be equal to zero, and the IST may equal to the PIST. For instance, the dashed circle 703 as shown in FIG. 7B. PIST may be equal to the length of B′C′.

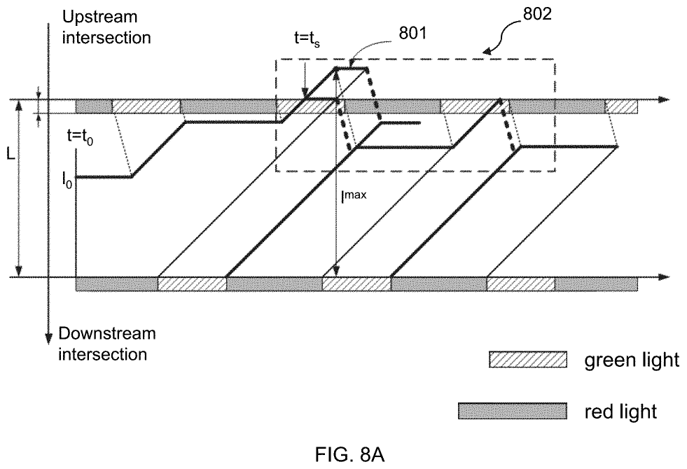

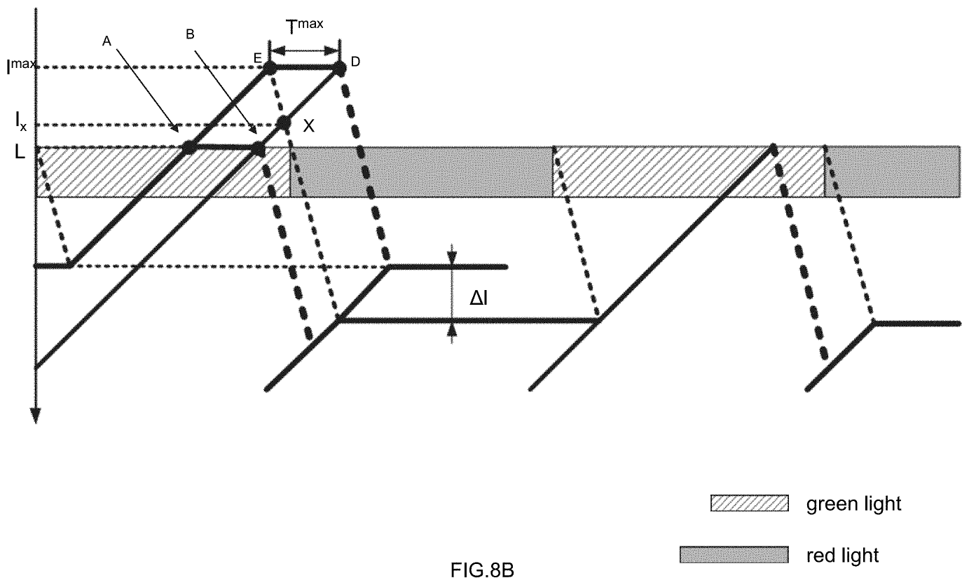

Nevertheless, the case as illustrated in FIG. 7A and FIG. 7B is not the only case. In some embodiments, the crossover point X is beyond the link length, as shown in FIG. 8A and FIG. 8B. FIG. 8A is schematic diagram illustrating exemplary queue length trajectories in a spillover on one road according to some embodiments of the present disclosure, and FIG. 8B is an enlarged view of the spillover part 802 in FIG. 8A.

The case as illustrated in FIG. 8A and FIG. 8B may occur when the discharge wave starting from the downstream intersection reaches the upstream stop line during its green light time. In the second case, queues may stop at the upstream intersection are always able to be dissolved at the same green duration in which the queue reaches the upstream intersection. As a consequence, no PIST arises, and the perpendicular side street is not affected. For FIG. 8A, the expressions of BIST and PIST may be derived directly from Equations (15) and (16) as follows:

BIST=T^{max} (15),

PIST=0 (16).

It should be noted that Equations (15) and (16) still hold for the case as illustrated in FIG. 8A and FIG. 8B. As shown in FIG. 4 and FIG. 5, once a spillover takes place, some vehicles cannot enter the road segment from the upstream intersection during a green light time. An inflow rate from the upstream intersection may be reduced due to a spillover, making the queue length in a next cycle smaller than its initial value. A difference, Δl, is described as:

$$Δ l = \{ \begin{matrix}{l}^{max} - L , & for the first case \\ {l}^{max} - {l}_{X} , & for the second case\end{matrix} \} = B I S T \cdot \frac{wv}{w + v} . \qquad ( 17 )$$

Afterward, the queue is discharged and re-formed cyclically similar to that in FIG. 7A and FIG. 7B. It is easy to find that the queue length trajectory may converge to a new cyclic pattern whose maximum value is exactly the length of the road segment. Moreover, although the queues reach the upstream stop line every cycle, they would not block any inflow traffic from the upstream. In the first case (as shown in FIG. 7A), the queue length may equal to the maximum value (i.e., the length of the road segment L) at the end of a green light duration. In the second case (as shown in FIG. 7B), the queue may be dissolved immediately after its length reaches the maximum value (i.e., the length of the road segment L). Consequently, there is no BIST in any of the further cycles.

A long-term impact of PIST may be significant. According to FIG. 7A, as long as queued vehicles occupy the upstream intersection at an end of a green light time, PIST may take place. And a value of PIST may be determined by a relative time within a cycle when the back-propagation wave from the downstream intersection reaches the upstream intersection, which is unchanged in every cycle. Therefore, a length of B′C′ equals a length of BC in FIG. 8B. Once PIST takes place, it may persist with a constant value in every future cycle as long as demands are sufficient, and drivers keep pouring in. Comparing the first case and the second case, a relative time within a cycle when the discharge wave from the downstream intersection reaches the upstream stop line is a critical character of a road segment that determines whether PIST will arise and persist. One binary variable, denoted as θᵢ, may be described that whether a downstream discharge wave on a road segment (i) reaches the upstream stop line during its green light or red-light durations, which may be determined according to Equation (18) as follows:

$${θ}_{i} = \{ \begin{matrix}0 , & condition 1 \\ 1 , & condtion 2\end{matrix} , \qquad ( 18 )$$

where condition 1 is if downstream discharge wave on road segment (i) reaches upstream stop line during a green light, and condition 2 is if downstream discharge wave on road segment (i) reaches upstream stop line during a red light.

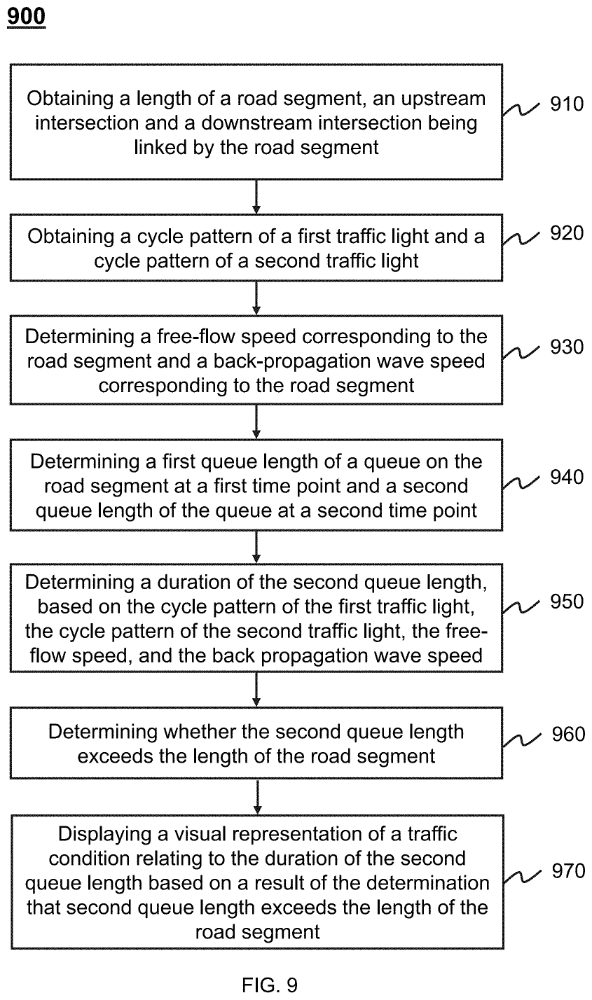

FIG. 9 is a flowchart illustrating an exemplary process for determining a traffic condition according to some embodiments of the present disclosure. The process 900 may be executed by the system 100. For example, the process 900 may be implemented as a set of instructions (e.g., an application) stored in the storage device 130. The processing engine 112 may execute the set of instructions and, when executing the instructions, it may be configured to perform the process 900. The operations of the illustrated process presented below are intended to be illustrative. In some embodiments, the process 900 may be accomplished with one or more additional operations not described and/or without one or more of the operations discussed. Additionally, the order in which the operations of the process as illustrated in FIG. 9 and described below is not intended to be limiting.

In 910, the processor (e.g., the acquisition module 410 of the processing engine 112) may obtain a length of a road segment. In some embodiments, the processor may obtain the length of a road segment via the information source 150. An upstream intersection and a downstream intersection may be linked by the road segment. The length of the road segment may be a distance from the upstream intersection to downstream intersection.

In 920, the processor (e.g., the acquisition module 410 of the processing engine 112) may obtain the cycle length of a first traffic light and the cycle length of a second traffic light. In some embodiments, the processor may obtain the cycle length of a traffic light via the information source 150. The first traffic light may be located at the downstream intersection. The second traffic light may be located at the upstream intersection. The cycle length of a traffic light refers to a periodical duration of the traffic light including a green-light duration, a red-light duration, and/or a yellow-light duration. In the present disclosure, the red-light duration and the green-light duration are discussed while the yellow-light duration is not discussed, but a person having ordinary skill in the art would understand how to include the yellow-light duration in view of the present disclosure without undue experimentation. In some embodiments, the yellow-light duration may be considered to be included in the green-light duration or the red-light duration.

In 930, the processor (e.g., the determination module 420 of the processing engine 112) may determine a free-flow speed corresponding to the road segment and a back-propagation wave speed corresponding to the road segment. In some embodiments, the processor may determine the free-flow speed and back-propagation wave speed based on traffic data.

The processor (e.g., the determination module 420 of the processing engine 112) may obtain traffic data related to the road segment via the information source 150. In some embodiments, the traffic data related to the road segment may include traffic flow rate and traffic density of the road segment. The processor (e.g., the determination module 420 of the processing engine 112) may determine the free-flow speed corresponding to the road segment and a back-propagation wave speed corresponding to the road segment based on the traffic flow rate and traffic density.

For example, the processor (e.g., the determination module 420 of the processing engine 112) may determine a first vector corresponding to a first status of the road segment based on the traffic data related to the road segment, where the first status is that the vehicle flow rate of the road segment is positively correlated to the vehicle density of the road segment corresponding to the vehicle flow rate. The processor (e.g., the determination module 420 of the processing engine 112) may determine the free-flow speed based on the first vector. For instance, as illustrated in FIG. 5B, the processor (e.g., the determination module 420 of the processing engine 112) may obtain traffic data (traffic flow rate and traffic density) related to the road segment via the information source 150. The processor (e.g., the determination module 420 of the processing engine 112) may determine a first vector related to the free-flowing status of the road (represented by the first vector from 510 pointing to 520 as shown in FIG. 5B) and determine the free-flow speed based on the slope of the first vector related to the free-flowing status of the road.

The processor (e.g., the determination module 420 of the processing engine 112) may also determine a second vector corresponding to a second status of the road segment based on the traffic data related to the road segment, where the second status is that the vehicle flow rate of the road segment is negatively correlated to the vehicle density of the road segment corresponding to the vehicle flow rate. The processor (e.g., the determination module 420 of the processing engine 112) may determine the back-propagation wave speed based on the second vector. For instance, as illustrated in FIG. 5B, the processor (e.g., the determination module 420 of the processing engine 112) may obtain traffic data (traffic flow rate and traffic density) related to the road segment via the information source 150. The processor (e.g., the determination module 420 of the processing engine 112) may determine a second vector related to the capacity status of the road (represented by a second vector from 520 pointing to 530 as shown in FIG. 5B) and determine the back-propagation wave speed based on the slope of the second vector related to capacity status of the road.

In 940, the processor (e.g., the determination module 420 of the processing engine 112) may determine a first queue length of a queue on the road segment at a first time point and a second queue length of the queue at a second time point. The first queue length may be the initial queue length l₀ as illustrated in FIG. 6. For instance, an initial condition at time t=t₀ (e.g., the first time point) may be assumed as that a queue with n₀ vehicles (i.e., the number of the vehicles equal to n₀) accumulates on the road. The processor (e.g., the determination module 420 of the processing engine 112) may determine the initial queue length l₀ (e.g., the first queue length) based on l₀=n₀×ρⱼ.

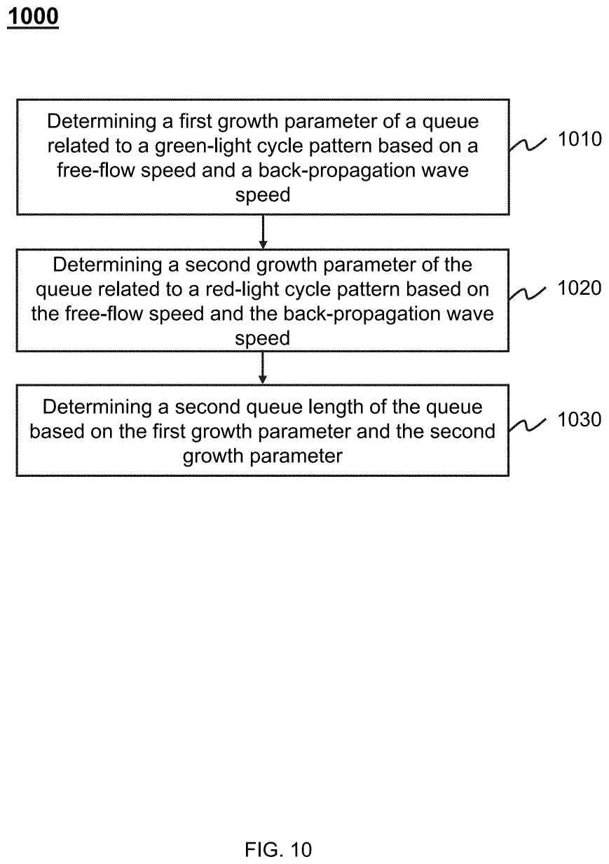

The second queue length of the queue may be the maximum queue length l^{max} as illustrated in FIG. 6. The processor (e.g., the determination module 420 of the processing engine 112) may determine the second queue length of the queue based on Equation (8). Detailed descriptions related to the second queue length of the queue may be found elsewhere in this disclosure (e.g., FIG. 10 and the descriptions thereof).

In 950, the processor (e.g., the determination module 420 of the processing engine 112) may determine the duration of the second queue length, based on the cycle length of the first traffic light, the cycle length of the second traffic light, the free-flow speed, the back-propagation wave speed, and the first queue length. The duration of the second queue length may be a duration that the second queue length (e.g., the maximum queue length) lasts. For instance, as illustrated in FIG. 6, the duration of the second queue length may be the duration of Stage (5) or Stage (10).

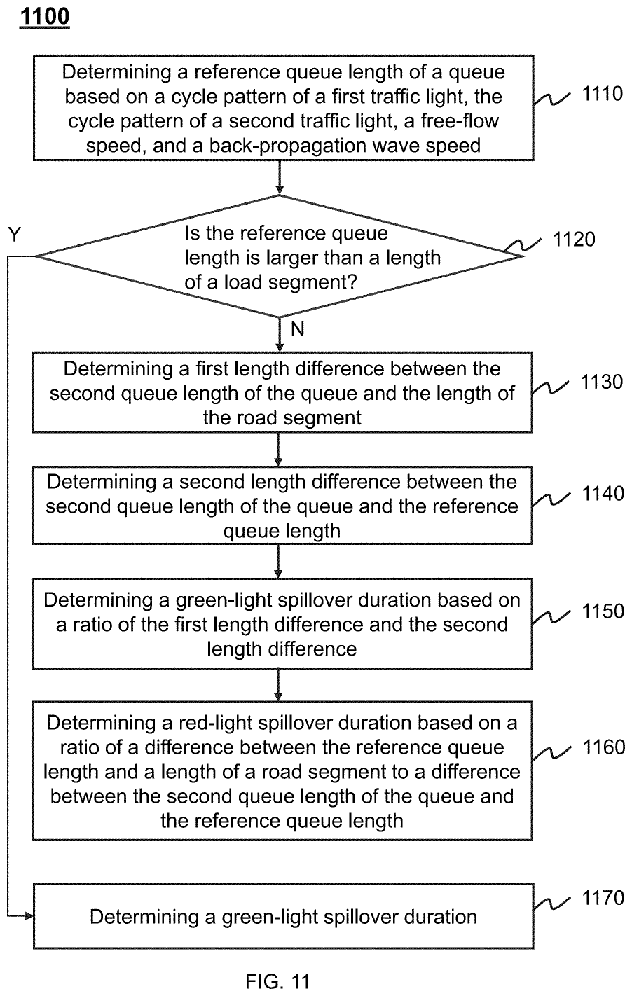

The processor (e.g., the determination module 420 of the processing engine 112) may determine the duration of the second queue length based on Equation (9). In some embodiments, the duration of the second queue length may include only a green-light spillover duration. In some embodiments, the duration of the second queue length may include only a red-light spillover duration. In some embodiments, the duration of the second queue length may include a green-light spillover duration and a red-light spillover duration. Detailed description related to the determination of the duration of the second queue length may be found elsewhere in this disclosure (e.g., in FIG. 11 and the descriptions thereof).

In 960, the processor may determine (e.g., the determination module 420 of the processing engine 112) whether the second queue length exceeds the length of the road segment. If the processor determines that the second queue length exceeds the length of the road segment, the processor may determine that there is a spillover on the road segment; that is, there may be congestion on the road segment.

In 970, the processor may cause a display device to display a visual representation of a traffic condition relating to the duration of the second queue length based on a result of the determination that the second queue length exceeds the length of the road segment (which may mean that there may be congestion on the road segment). For example, the processor may cause a display device to display the duration of the second queue length if the processor determines that the second length exceeds the length of the road segment and a warning relating to the road segment (e.g., there is a spillover on the road segment). The processor may send information of the duration of the second queue length and the warning to a passenger terminal and/or a driver terminal.

The passenger terminal and/or the driver terminal may display traffic status relating to the road segment, and display whether there is a spillover on the road segment on a map. In some embodiments, the passenger terminal and/or the driver terminal may display traffic status relating to a plurality of road segments and display whether there is a spillover on the plurality of road segments on the map, respectively. In some embodiments, the passenger terminal and/or the driver terminal may plan a rational route based on the traffic status relating to the plurality of road segments for a passenger associated with the passenger terminal and/or a driver associated with the driver terminal to avoid congestion. For example, a road segment with congestion may be avoided in a planned route.

It should be noted that the above descriptions of process 900 are provided for the purposes of illustration, and not intended to limit the scope of the present disclosure. For persons having ordinary skills in the art, various modifications and changes in the forms and details of the application of the above method and system may occur without departing from the principles in the present disclosure. However, those variations and modifications also fall within the scope of the present disclosure. In some embodiments, one or more steps may be added or omitted. For example, steps 901 and 902 may be merged into one step.

FIG. 10 is a flowchart illustrating an exemplary process for determining a second queue length of a queue according to some embodiments of the present disclosure. The process 1000 may be executed by the system 100. For example, the process 1000 may be implemented as a set of instructions (e.g., an application) stored in the storage device 130. The processing engine 112 may execute the set of instructions and, when executing the instructions, it may be configured to perform the process 1000. The operations of the illustrated process presented below are intended to be illustrative. In some embodiments, the process 1000 may be accomplished with one or more additional operations not described and/or without one or more of the operations discussed. Additionally, the order in which the operations of the process as illustrated in FIG. 10 and described below is not intended to be limiting. In some embodiments, the determination of a second queue length of a queue in operation 940 of the process 900 described above may be determined according to the process 1000.

In 1010, the processor (e.g., the determination module 420 of the processing engine 112) may determine a first growth parameter of a queue related to a green-light cycle length based on a free-flow speed and a back-propagation wave speed. The first growth parameter may correspond to the growth of the queue length in one green light period. As illustrated in FIG. 6, the processor (e.g., the determination module 420 of the processing engine 112) may determine the first growth parameter based on a triangle formed by auxiliary lines 603, 604 and the horizontal axis including a green-light cycle length. The slope of the auxiliary line 603 may be the free-flow speed, and the slope of the auxiliary line 604 may be the back-propagation wave speed w. Detailed descriptions of determination of the flow speed and the back-propagation wave speed may be found elsewhere in this disclosure (e.g., FIG. 5 and the descriptions thereof). The processor (e.g., the determination module 420 of the processing engine 112) may also determine the first growth parameter based on Equation (3) described above.

In 1020, the processor (e.g., the determination module 420 of the processing engine 112) may determine a second growth parameter of a queue related to a red-light cycle length based on a free-flow speed and a back-propagation wave speed. The second growth parameter may correspond to the growth of the queue length in one red light period. As illustrated in FIG. 6, the processor (e.g., the determination module 420 of the processing engine 112) may determine the second growth parameter based on a triangle formed by the auxiliary lines 605, 606 and the horizontal axis including a red-light cycle length. The slope of the auxiliary line 605 may be the free-flow speed v, and the slope of the auxiliary line 606 may be the back-propagation wave speed w. Detailed descriptions of determination of the flow speed and the back-propagation wave speed may be found elsewhere in this disclosure (e.g., FIG. 5 and the descriptions thereof). The processor (e.g., the determination module 420 of the processing engine 112) may also determine the second growth parameter based on Equation (4) described above.

In 1030, the processor (e.g., the determination module 420 of the processing engine 112) may determine the second queue length of the queue based on the first growth parameter and the second growth parameter. In some embodiments, the processor (e.g., the determination module 420 of the processing engine 112) may determine the second queue length of the queue based on Equation (9).

It should be noted that the above description of the process for determining a second queue length of a queue is provided for the purpose of illustration, and not intended to limit the scope of the present disclosure. For persons having ordinary skills in the art, modules may be combined in various ways, or connected with other modules as sub-systems. Various variations and modifications may be conducted under the teaching of the present disclosure. However, those variations and modifications may not depart from the spirit and scope of this disclosure.

FIG. 11 is a flowchart illustrating an exemplary process for determining a green-light spillover duration and/or a red-light spillover duration according to some embodiments of the present disclosure. The process 1100 may be executed by the system 100. For example, the process 1100 may be implemented as a set of instructions (e.g., an application) stored in the storage device 130. The processing engine 112 may execute the set of instructions and, when executing the instructions, it may be configured to perform the process 1100. The operations of the illustrated process presented below are intended to be illustrative. In some embodiments, the process 1100 may be accomplished with one or more additional operations not described and/or without one or more of the operations discussed. Additionally, the order in which the operations of the process as illustrated in FIG. 11 and described below is not intended to be limiting. In some embodiments, operation 950 of the process 900 may be performed according to the process 1100.

In 1110, the processor (e.g., the determination module 420 of the processing engine 112) may determine a reference queue length of a queue based on a cycle length of a first traffic light, a cycle length of a second traffic light, a free-flow speed, and a back-propagation wave speed. The reference queue length may be the position of the crossover point X in a time-space diagram as illustrated FIG. 7A, FIG. 7B, FIG. 8A, and FIG. 8B. The processor (e.g., the determination module 420 of the processing engine 112) may determine the reference queue length based on Equation (14) described above. Detailed descriptions related to the position of the crossover point X in the time-space diagram (Ix) may be found elsewhere in the present disclosure (e.g., FIG. 7A, FIG. 7B, FIG. 8A, FIG. 8B, and the descriptions thereof).

In 1120, the processor (e.g., the determination module 420 of the processing engine 112) may determine whether the reference queue length is larger than the length of a road segment. If the processor determines that the reference queue length is larger than the length of the road segment, the duration of the second queue length may only include a green-light spillover and the process 1100 may proceed to 1170. If the processor determines that the reference queue length is equal to or less than the length of the road segment, the duration of the second queue length may include a green-light spillover and/or a red-light spillover and the process 1100 may proceed to 1130.

In 1130, the processor (e.g., the determination module 420 of the processing engine 112) may determine a first length difference between the second queue length of the queue and the length of the road segment. The processor (e.g., the determination module 420 of the processing engine 112) may determine the first length difference based on (l^{max}−L).

In 1140, the processor (e.g., the determination module 420 of the processing engine 112) may determine a second length difference between the second queue length of the queue and the reference queue length. The processor (e.g., the determination module 420 of the processing engine 112) may determine the second length difference based on (l^{max}−lₓ).

In 1150, the processor (e.g., the determination module 420 of the processing engine 112) may determine a green-light spillover duration based on the ratio of the first length difference to the second length difference. The processor (e.g., the determination module 420 of the processing engine 112) may determine the green-light spillover duration based on Equation (13) described above. In this case, the method for determining a traffic condition in FIG. 9 may include displaying, by a display device, a visual representation of a second indicator related to the green-light spillover duration.

In 1160, the processor (e.g., the determination module 420 of the processing engine 112) may determine the red-light spillover duration based on the ratio of the difference between the reference queue length and the length of the road segment to the difference between the second queue length of the queue and the reference queue length. The processor (e.g., the determination module 420 of the processing engine 112) may determine the green-light spillover duration based on Equation (14) described above. In this case, the method for determining a traffic condition in FIG. 9 may include displaying, by a display device, a visual representation of a third indicator related to the red-light spillover duration.

In some embodiments, the processor may also determine a sum of the green-light spillover duration and the red-light spillover duration as the duration of the second queue length.

In 1170, the processor (e.g., the determination module 420 of the processing engine 112) may determine a green-light spillover duration as the duration of the second queue length based on a result of the determination that the reference queue length exceeds the length of the road segment.

In some embodiments, the method for determining a traffic condition in FIG. 9 may include displaying, by a display device, a visual representation of a fourth indicator related to the green-light spillover duration.

It should be noted that the above description of the process for determining a green-light spillover duration and/or a red-light spillover duration is provided for the purpose of illustration, and not intended to limit the scope of the present disclosure. For persons having ordinary skills in the art, modules may be combined in various ways, or connected with other modules as sub-systems. Various variations and modifications may be conducted under the teaching of the present disclosure. However, those variations and modifications may not depart from the spirit and scope of this disclosure.

To implement various modules, units, and their functionalities described in the present disclosure, computer hardware platforms may be used as the hardware platform(s) for one or more of the elements described herein. A computer with user interface elements may be used to implement a personal computer (PC) or any other type of work station or terminal device. A computer may also act as a server if appropriately programmed.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer-readable media having computer readable program code embodied thereon.

A computer readable signal medium may include a propagated data signal with computer readable program code embodied therein, for example, in baseband or as part of a carrier wave. Such a propagated signal may take any of a variety of forms, including electromagnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object-oriented programming language such as Java, Scala, Smalltalk, Eiffel, JADE, Emerald, C++, C#, VB. NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (e.g., through the Internet using an Internet Service Provider) or in a cloud computing environment or offered as a service such as a Software as a Service (SaaS).

Furthermore, the recited order of processing elements or sequences, or the use of numbers, letters, or other designations, therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

1. A method implemented on a computing device for determining a traffic condition, the computing device including a memory and processing circuits, the method comprising:
obtaining, by processing circuits, signals including a length of a road segment, an upstream intersection and a downstream intersection being linked by the road segment;
obtaining, by the processing circuits, signals including a cycle length of a first traffic light and a cycle length of a second traffic light, the first traffic light being located at the downstream intersection, the second traffic light being located at the upstream intersection;
determining, by the processing circuits, a free-flow speed corresponding to the road segment and a back-propagation wave speed corresponding to the road segment;
determining, by the processing circuits, a first queue length of a queue on the road segment at a first time point and a second queue length of the queue at a second time point;
determining, by the processing circuits, a duration of the second queue length, based on the cycle length of the first traffic light, the cycle length of the second traffic light, the free-flow speed, the back-propagation wave speed, and the first queue length;
determining, by the processing circuits, whether the second queue length exceeds the length of the road segment; and
displaying, by a display, a visual representation of a traffic condition relating to the duration of the second queue length based on a result of the determination that second queue length exceeds the length of the road segment.

2. The method of claim 1, wherein
a cycle length of a traffic light includes a green-light cycle length and a red-light cycle length; and
determining the second queue length of the queue at a second time point includes:
determining, by the processing circuits, a first growth parameter of the queue related to the green-light cycle length based on the free-flow speed and the back-propagation wave speed;
determining, by the processing circuits, a second growth parameter of the queue related to the red-light cycle length based on the free-flow speed and the back-propagation wave speed; and
determining, by the processing circuits, the second queue length of the queue based on the first growth parameter and the second growth parameter.

3. The method of claim 1, wherein
the duration of the second queue length includes a green-light spillover duration;
determining the duration of the second queue length includes:
determining, by the processing circuits, a reference queue length of the queue based on the cycle length of the first traffic light, the cycle length of the second traffic light, the free-flow speed, and the back-propagation wave speed;
determining, by the processing circuits, a first length difference between the second queue length of the queue and the length of the road segment;
determining, by the processing circuits, a second length difference between the second queue length of the queue and the reference queue length; and
determining, by the processing circuits, the green-light spillover duration based on a ratio of the first length difference and the second length difference; and
the method further includes displaying, by the display, a visual representation of a second indicator related to the green-light spillover duration.

4. The method of claim 3, wherein
the duration of the second queue length includes a red-light spillover duration; and
determining the duration of the second queue length includes:
determining, by the processing circuits, the red-light spillover duration based on a ratio of a difference between the reference queue length and the length of the road segment to a difference between the second queue length of the queue and the reference queue length; and
the method further includes displaying a third indicator related to the red-light spillover duration.

5. The method of claim 4, wherein determining the duration of the second queue length includes:
determine, by the processing circuits, a sum of the green-light spillover duration and the red-light spillover duration as the duration of the second queue length.

6. The method of claim 3, wherein the method further comprises:
determining, by the processing circuits, whether the reference queue length exceeds the length of the road segment;
determining, by the processing circuits, the green-light spillover duration as the duration of the second queue length based on a result of the determination that the reference queue length exceeds the length of the road segment; and
displaying, by the display, a visual representation of a fourth indicator related to the green-light spillover duration.

7. The method of claim 1, wherein determining the free-flow speed corresponding to the road segment comprises:
obtaining, by the processing circuits the one or more processors, signals including traffic data related to the road segment, the traffic data related to the road segment including a vehicle flow rate of the road segment and a vehicle density of the road segment corresponding to the vehicle flow rate;
determining, by the processing circuits, a first vector corresponding to a first status of the road segment based on the traffic data related to the road segment, wherein the first status is that the vehicle flow rate of the road segment is positively correlated to the vehicle density of the road segment corresponding to the vehicle flow rate; and
determining, by the processing circuits, the free-flow speed based on the first vector.

8. The method of claim 1, wherein determining the back-propagation wave speed corresponding to the road segment comprises:
obtaining, by the processing circuits, signals including traffic data related to the road segment, the traffic data related to the road segment including a vehicle flow rate of the road segment and a vehicle density of the road segment corresponding to the vehicle flow rate;
determining, by the processing circuits, a second vector corresponding to a second status of the road segment based on the traffic data related to the road segment, wherein the second status is that the vehicle flow rate of the road segment is negatively correlated to the vehicle density of the road segment corresponding to the vehicle flow rate; and
determining, by the processing circuits, the back-propagation wave speed based on the second vector.

9. A system configured for determining a traffic condition, comprising:
at least one non-transitory storage medium including a set of instructions; and
processing circuits in communication with the at least one non-transitory storage medium, wherein when executing the set of instructions, the processing circuits are directed to:
obtain signals including a length of a road segment, an upstream intersection and a downstream intersection being linked by the road segment;
obtain signals including a cycle length of a first traffic light and a cycle length of a second traffic light, the first traffic light being located at the downstream intersection, the second traffic light being located at the upstream intersection;
determine a free-flow speed corresponding to the road segment and a back-propagation wave speed corresponding to the road segment;
determine a first queue length of a queue on the road segment at a first time point and a second queue length of the queue at a second time point;
determine a duration of the second queue length, based on the cycle length of the first traffic light, the cycle length of the second traffic light, the free-flow speed, the back-propagation wave speed, and the first queue length;
determine whether the second queue length exceeds the length of the road segment; and
cause a display to display a visual representation of a traffic condition relating to the duration of the second queue length based on a result of the determination that second queue length exceeds the length of the road segment.

10. The system of claim 9, wherein
a cycle length of a traffic light includes a green-light cycle length and a red-light cycle length; and
to determine the second queue length of the queue at a second time point, the processing circuits are further directed to:
determine a first growth parameter of the queue related to the green-light cycle length based on the free-flow speed and the back-propagation wave speed;
determine a second growth parameter of the queue related to the red-light cycle length based on the free-flow speed and the back-propagation wave speed; and
determine the second queue length of the queue based on the first growth parameter and the second growth parameter.

11. The system of claim 9, wherein
the duration of the second queue length includes a green-light spillover duration;
to determine the second queue length of the queue at a second time point, the processing circuits are further directed to:
determine a reference queue length of the queue based on the cycle length of the first traffic light, the cycle length of the second traffic light, the free-flow speed, and the back-propagation wave speed;
determine a first length difference between the second queue length of the queue and the length of the road segment;
determine a second length difference between the second queue length of the queue and the reference queue length; and
determine the green-light spillover duration based on a ratio of the first length difference and the second length difference; and
display a visual representation of a second indicator related to the green-light spillover duration.

12. The system of claim 11, wherein
the duration of the second queue length includes a red-light spillover duration, and
to determine the duration of the second queue length, the processing circuits are further directed to:
determine the red-light spillover duration based on a ratio of a difference between the reference queue length and the length of the road segment to a difference between the second queue length of the queue and the reference queue length; and
display a third indicator related to the red-light spillover duration.

13. The system of claim 12, wherein to determine the duration of the second queue length, the processing circuits are directed to:
determine a sum of the green-light spillover duration and the red-light spillover duration as the duration of the second queue length.

14. The system of claim 11, wherein the processing circuits are further directed to:
determine whether the reference queue length exceeds the length of the road segment;
determine the green-light spillover duration as the duration of the second queue length based on a result of the determination that the reference queue length exceeds the length of the road segment; and
cause a display to display a visual representation of a fourth indicator related to the green-light spillover duration.

15. The system of claim 9, wherein to determine the free-flow speed corresponding to the road segment, the processing circuits are further directed to:
obtain signals including traffic data related to the road segment, the traffic data related to the road segment including a vehicle flow rate of the road segment and a vehicle density of the road segment corresponding to the vehicle flow rate;
determine a first vector corresponding to a first status of the road segment based on the traffic data related to the road segment, wherein the first status is that the vehicle flow rate of the road segment is positively correlated to the vehicle density of the road segment corresponding to the vehicle flow rate; and
determine the free-flow speed based on the first vector.

16. The system of claim 9, wherein to determine the back-propagation wave speed corresponding to the road segment, the processing circuits are further directed to:
obtain signals including traffic data related to the road segment, the traffic data related to the road segment including a vehicle flow rate of the road segment and a vehicle density of the road segment corresponding to the vehicle flow rate;
determine a second vector corresponding to a second status of the road segment based on the traffic data related to the road segment, wherein the second status is that the vehicle flow rate of the road segment is negatively correlated to the vehicle density of the road segment corresponding to the vehicle flow rate; and
determine the back-propagation wave speed based on the second vector.

17. A non-transitory computer readable medium embodying a computer program product, the computer program product comprising instructions configured to cause a computing device to:
obtaining signals including a length of a road segment, an upstream intersection and a downstream intersection being linked by the road segment;
obtaining signals including a cycle length of a first traffic light and a cycle length of a second traffic light, the first traffic light being located at the downstream intersection, the second traffic light being located at the upstream intersection;
determining a free-flow speed corresponding to the road segment and a back-propagation wave speed corresponding to the road segment;
determining a first queue length of a queue on the road segment at a first time point and a second queue length of the queue at a second time point;
determining a duration of the second queue length, based on the cycle length of the first traffic light, the cycle length of the second traffic light, the free-flow speed, the back-propagation wave speed, and the first queue length;
determining whether the second queue length exceeds the length of the road segment; and
displaying a visual representation of a traffic condition relating to the duration of the second queue length based on a result of the determination that second queue length exceeds the length of the road segment.

18. The non-transitory computer readable medium of claim 17, wherein
a cycle length of a traffic light includes a green-light cycle length and a red-light cycle length; and
determining the second queue length of the queue at a second time point includes:
determining a first growth parameter of the queue related to the green-light cycle length based on the free-flow speed and the back-propagation wave speed;
determining a second growth parameter of the queue related to the red-light cycle length based on the free-flow speed and the back-propagation wave speed; and
determining the second queue length of the queue based on the first growth parameter and the second growth parameter.

19. The non-transitory computer readable medium of claim 17, wherein
the duration of the second queue length includes a green-light spillover duration;
determining the duration of the second queue length includes:
determining a reference queue length of the queue based on the cycle length of the first traffic light, the cycle length of the second traffic light, the free-flow speed, and the back-propagation wave speed;
determining a first length difference between the second queue length of the queue and the length of the road segment;
determining a second length difference between the second queue length of the queue and the reference queue length; and
determining the green-light spillover duration based on a ratio of the first length difference and the second length difference; and
displaying a visual representation of a second indicator related to the green-light spillover duration.

20. The non-transitory computer readable medium of claim 19, wherein
the duration of the second queue length includes a red-light spillover duration; and
determining the duration of the second queue length includes:
determining the red-light spillover duration based on a ratio of a difference between the reference queue length and the length of the road segment to a difference between the second queue length of the queue and the reference queue length; and
displaying a third indicator related to the red-light spillover duration.
